(19) United States
(12) Patent Application Publication
(10) Pub. No.: US 2025/0342485 A1
(43) Pub. Date: Nov. 6, 2025

(54) SYSTEM EMPLOYING AN OBJECT-ORIENTED KNOWLEDGE GRAPH DATA STRUCTURE INTEGRATED WITH ADVANCED NEURAL NETWORKS AND ARTIFICIAL INTELLIGENCE MECHANISMS TO SIMPLIFY AND STREAMLINE ACCESS TO AND USE OF REGULATIONS, STANDARDS, AND REQUIREMENTS

(71) Applicant: Omitz, LLC, Louisville, CO (US)

(72) Inventors: Phillip Clark, Louisville, CO (US); Nathan Clark, Lawrence, KS (US)

(73) Assignee: Omitz, LLC, Louisville, CO (US)

(21) Appl. No.: 19/195,910

(22) Filed: May 1, 2025

Related U.S. Application Data
(60) Provisional application No. 63/641,526, filed on May 2, 2024.

(51) Int. Cl. G06Q 30/018

(52) U.S. Cl. CPC G06Q 30/018

(57) ABSTRACT

Computerized system and method for facilitating compliance with regulations, standards and/or requirements employ graph database systems and knowledge graph (KG) structures and storage in JavaScript Object Notation (JSON) format for executing searches and displaying requested information in a manner that preserves the hierarchy of the regulatory, standards and/or requirements documents, Artificial intelligence (AI) chatbot components are also implemented which allow for receipt of prompts relating to a the regulatory, standards and/or requirements documents, and provide the prompt to the AI chatbot, and providing an answer to the prompts.

### CROSS REFERENCE TO RELATED APPLICATIONS

This application claims priority to U.S. Provisional Patent Application Ser. No. 63/641,526, filed on May 2, 2024, and titled “System Employing an Object-Oriented Knowledge Graph Data Structure Integrated with Advanced Neural Networks and Artificial Intelligence Mechanisms to Simplify and Streamline Access to and use of Regulations, Standards, and Requirements,” the disclosure of which is incorporated herein by reference.

### FIELD OF THE INVENTION

The disclosed concept relates generally to regulatory compliance, and more particularly to a solution designed to simplify and enhance the accuracy of regulatory compliance, thereby addressing the need for a more streamlined and reliable approach in this technical field.

### BACKGROUND OF THE INVENTION

Many industries are governed by a complex set of regulations, standards and requirements. For example, clean energy technologies are governed by a large number of such regulations, standards and requirements, several of which are extremely voluminous, with numerous headings, sections, subsections and internal and/or external references. In these industries, adherence to such standards and requirements is imperative. Existing methods for managing and complying with these standards and requirements are often inefficient and error-prone, particularly for entities navigating these standards for the first time or adapting to their rapid evolution.

### SUMMARY OF THE INVENTION

In one embodiment, a system for facilitating compliance with regulations, standards and/or requirements using a client computer is provided. The system includes a provider computing system located remotely from the client computer, a backend database system coupled to the provider computing system, the backend database system storing a plurality of regulatory, standards and/or requirements documents, wherein each of the regulatory, standards and/or requirements documents is stored in a text-based format and is organized according to a respective predetermined hierarchy, and a graph database system coupled to the computing device. The provider computing system is structured and configured to: implement a parser component, the parser component being configured to convert each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document, for each of the regulatory, standards and/or requirements documents in the JSON format, push the regulatory, standards and/or requirements document in the JSON format to the graph database system wherein the regulatory, standards and/or requirements document in the JSON format is represented by a knowledge graph (KG) structure, for a particular one of the regulatory, standards and/or requirements documents stored in the backend database system, receive a number of search terms from the client computer, identify a number of nodes in the KG structure corresponding to the particular one of the regulatory, standards and/or requirements documents based on the number of search terms, and cause the client computer to display a number of portions of the particular one of the regulatory, standards and/or requirements documents based on the identified nodes in a manner that preserves the hierarchy of the particular one of the regulatory, standards and/or requirements documents.

In another embodiment, a method for facilitating compliance by a user with regulations, standards and/or requirements is provided. The method includes storing in a backend database system a plurality of regulatory, standards and/or requirements documents, wherein each of the regulatory, standards and/or requirements documents is stored in a text-based format and is organized according to a respective predetermined hierarchy; converting each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document, for each of the regulatory, standards and/or requirements documents in the JSON format, pushing the regulatory, standards and/or requirements document in the JSON format to a graph database system wherein the regulatory, standards and/or requirements document in the JSON format is represented by a knowledge graph (KG) structure, for a particular one of the regulatory, standards and/or requirements documents stored in the backend database system, receiving a number of search terms from the user, identifying a number of nodes in the KG structure corresponding to the particular one of the regulatory, standards and/or requirements documents based on the number of search terms, and causing a number of portions of the particular one of the regulatory, standards and/or requirements documents based on the identified nodes to be displayed to the user in a manner that preserves the hierarchy of the particular one of the regulatory, standards and/or requirements documents.

In still another embodiment, a system for facilitating compliance with regulations, standards and/or requirements using a client computer is provided. The system includes a provider computing system located remotely from the client computer, a backend database system coupled to the provider computing system, the backend database system storing a plurality of regulatory, standards and/or requirements documents, wherein each of the regulatory, standards and/or requirements documents is stored in a text-based format and is organized according to a respective predetermined hierarchy, and a graph database system coupled to the computing device. The provider computing system is structured and configured to implement a parser component, the parser component being configured to convert each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document, for each of the regulatory, standards and/or requirements documents in the JSON format, push the regulatory, standards and/or requirements document in the JSON format to the graph database system wherein the regulatory, standards and/or requirements document in the JSON format is represented by a knowledge graph (KG) structure, implement an artificial intelligence (AI) chatbot component, the AI chatbot component enabling an AI chatbot that is configured to (i) allow the client computer to receive a prompt relating to a particular one of the regulatory, standards and/or requirements documents and provide the prompt to the AI chatbot, and (ii) provide an answer to the prompt.

In yet another embodiment, a method for facilitating compliance by a user with regulations, standards and/or requirements is provided. The method includes storing in a backend database system a plurality of regulatory, standards and/or requirements documents, wherein each of the regulatory, standards and/or requirements documents is stored in a text-based format and is organized according to a respective predetermined hierarchy, converting each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document, for each of the regulatory, standards and/or requirements documents in the JSON format, pushing the regulatory, standards and/or requirements document in the JSON format to a graph database system wherein the regulatory, standards and/or requirements document in the JSON format is represented by a knowledge graph (KG) structure, and providing an AI chatbot that is configured to (i) allow the user to provide a prompt relating to a particular one of the regulatory, standards and/or requirements documents to the AI chatbot, and (ii) provide an answer to the prompt.

### BRIEF DESCRIPTION OF THE DRAWINGS

A full understanding of the invention can be gained from the following description of the preferred embodiments when read in conjunction with the accompanying drawings in which:

FIG. 1 is a schematic diagram illustrating the system and method for simplifying and enhancing the accuracy of regulatory compliance according to the disclosed concept at a top level of operation;

FIG. 2 is an example screenshot based on an exemplary OSHA regulation which includes only relevant regulatory content according to an exemplary embodiment of the disclosed concept;

FIG. 3 is an example screenshot based on an exemplary OSHA regulation which includes both relevant and omitted regulatory content according to an exemplary embodiment of the disclosed concept;

FIG. 4 is an example screenshot based on an exemplary OSHA regulation wherein a user can choose to omit from a report certain relevant content;

FIG. 5 is a block diagram of a system for simplifying and streamlining the access to and use of regulations, standards, and requirements according to a non-limiting exemplary embodiment of the disclosed concept;

FIG. 6 is a block diagram of a provider sever computer forming part of the system of FIG. 5 according to a non-limiting exemplary embodiment;

FIGS. 7 and 8 schematically illustrate an aspect of the disposed concept which enables the search for and display of particular regulatory information according to a non-limiting exemplary embodiment; and

FIGS. 9-12 schematically illustrate two AI chatbot implementations according to non-limiting exemplary embodiments of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. While certain ways of displaying information to users are shown and described with respect to certain figures or graphs as screenshots, those skilled in the relevant art will recognize that various other alternatives can be employed.

As used herein, the term “controller” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of this innovation.

As described herein in connection with various exemplary embodiments, the disclosed concept provides a revolutionary system engineered to simplify and streamline the complex world of regulations, standards, and requirements. The disclosed concept may be particularly advantageous in the realm of clean energy technology, which is governed by a large number of complex regulations, standards, and requirements. The disclosed concept achieves the simplification and streamlining of content by employing a state-of-the-art object-oriented knowledge graph data structure integrated with advanced neural networks and artificial intelligence mechanisms as described herein. Users, whether they are seasoned experts or newcomers to a field, are granted a user-centric search experience tailored to their specific needs, making the process of understanding and complying with multifarious regulations more accessible and efficient.

In one aspect, the system of the disclosed concept employs an inter-document search engine that, upon initiation of a search query, dynamically adapts the output to the user's input. Specifically, as a user types in search terms, the content displayed to the user evolves, omitting irrelevant sections and highlighting pertinent content from a regulation, standard, and/or requirements document in real-time, thereby providing a user-centric search experience tailored to individual needs.

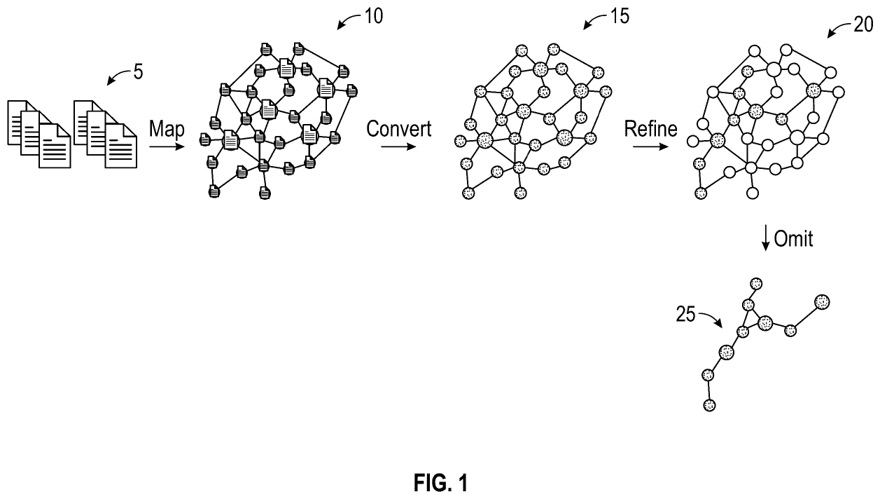

FIG. 1 is a schematic diagram illustrating the disclosed concept at a top level of operation. Each aspect of the disclosed concept shown in FIG. 1 is described in greater detail herein in connection with a number of non-limiting particular exemplary embodiments.

As seen in FIG. 1, the system of the disclosed concept starts with a regulation, standard, or requirements document of interest (in, for example and without limitation, Microsoft® Word format, pdf format or html format), labeled with reference number 5 in FIG. 1. That document may be, for example and without limitation, a particular regulation from the United States Code of Federal Regulations (CFR). As shown in FIG. 1, in an aspect of the disclosed concept, the content of document 5 is mapped to a JavaScript Object Notation (JSON) format/file, labelled with reference numeral 5, using a suitable parser script. The content in JSON format/file 10 maintains the hierarchy of the content of original document 5 such that the content and/or portions thereof can be displayed to the user with the hierarchy intact. The displayed information will thus look just like the original content. This is significant as nearly all regulatory, standards, and requirements content has a hierarchical format consisting of large number of sections, sub-sections, etc. In a further aspect of the disclosed concept, the content in JSON format/file 10 is pushed/imported to an object oriented database, also referred to herein as a graph database, where the content of JSON format/file 10 is converted to and represented by a knowledge graph (KG) structure/model 15. As illustrated in FIG. 1, KG structure/model 15 includes data elements in the form of (1) nodes, (2) edges connecting nodes, and (3) attributes of each of the nodes and the associated edge(s) that define the relationship between nodes and edges. The content represented by KG structure/model 15 may then be refined to include only selected portions thereof, labeled with reference numeral 20, based on input parameters (e.g., search terms from the user). This aspect of the disclosed concept uses a graph exploration application/tool that interacts with the stored KG data of KG structure/model 15 to identify only selected portions of the content as shown in FIG. 1.

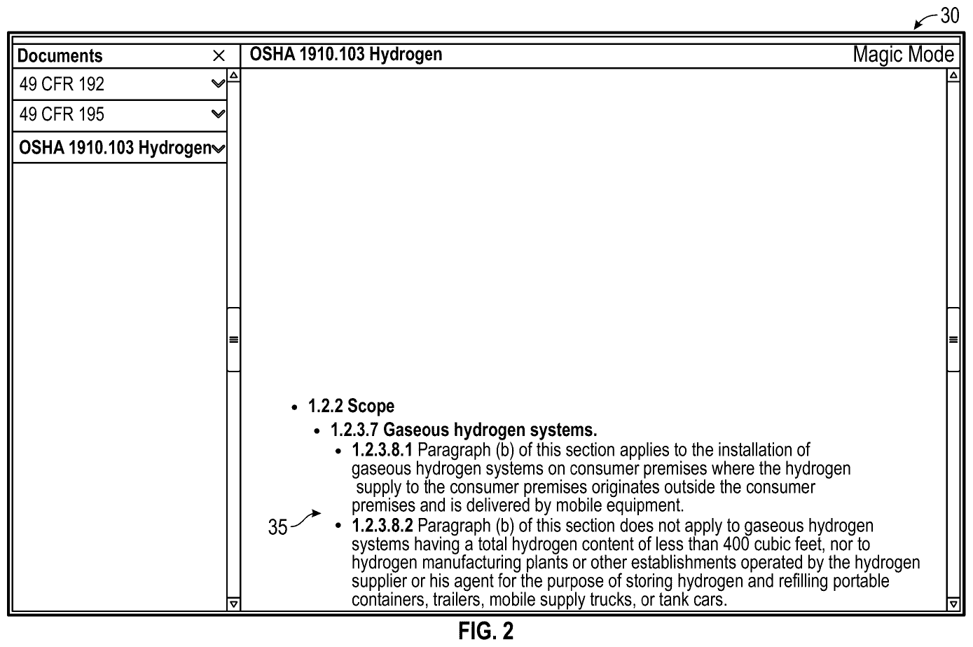

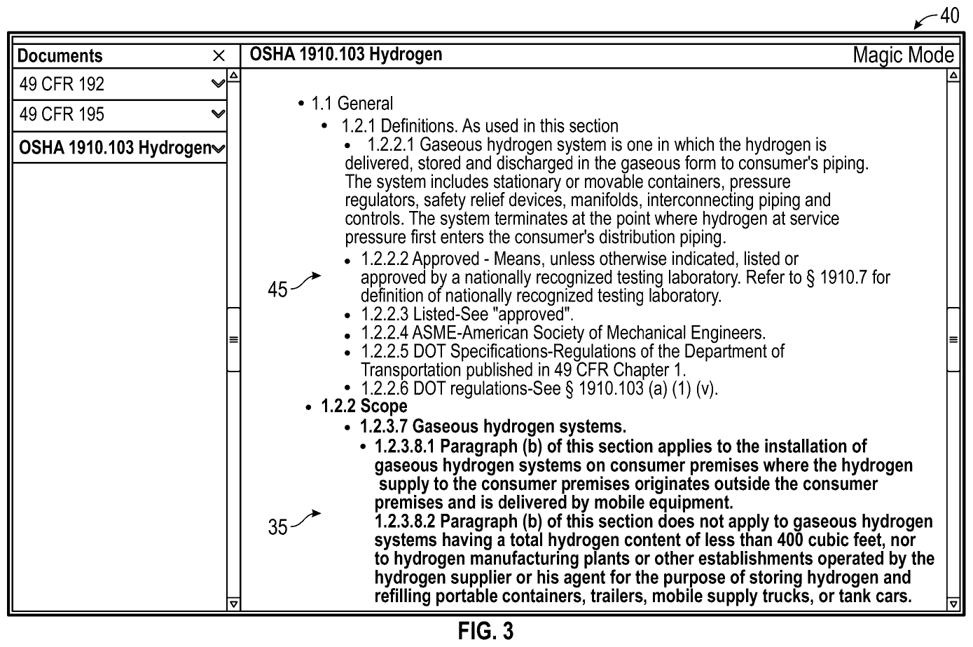

A further aspect of the disclosed concept as shown in FIG. 1 allows for the omission of non-identified/non-selected portions of the content, which is illustrated by reference numeral 25. The non-omitted portions of the KG may then be used to display only the selected portions of the content to the user with the original hierarchy intact. An exemplary implementation of this aspect is shown in the example screenshot 30 of FIG. 2 (based on an exemplary OSHA regulation) wherein screenshot 30 includes only relevant content 35. This feature provides the user with the ability to condense requirements into a fraction of what the document was initially. The omitted content may also, however, be revealed and displayed as needed by way of a user input/selection. Alternatively, the selected portions of the content may be displayed in a format where the selected portions are provided in a prominent font/format (e.g., bold), and the non-selected portions are displayed in a less prominent font/format (e.g., subtly faded), ensuring that the primary focus remains on the relevant content. An exemplary implementation of this aspect is shown in the example screenshot 40 of FIG. 3 (based on the same OSHA regulation), wherein screenshot 40 includes both relevant content 35 and omitted content 45. Users have the option to fully omit the irrelevant content or reveal it as required, which provides the user with the ability to condense requirements into a fraction of what the document was initially.

In a further aspect of the disclosed concept, the hierarchy of the regulatory content is acknowledged such that a search for a parent term or section also fetches its associated subordinate sections or subclauses. This ensures that the user receives a comprehensive view of related content (well beyond that which Ctrl+F could achieve). Furthermore, the disclosed concept recognizes both internal-references—internal, internal-references—external, external-references—internal, and external-references—external within content. Therefore, if a section of content refers to another segment of the content, the engine fetches the referenced part, ensuring that users have all the information they require without needing multiple searches. A number of examples of this aspect of the disclosed concept are provided elsewhere herein in connection with exemplary embodiments.

Moreover, Boolean searching, with its AND, OR, and NOT operators, has long been a gold standard in refining queries. Its application, however, can be complex for many users. Recognizing this, the disclosed concept employs a redesigned Boolean experience which is more user-friendly and visually intuitive. With this unique visual interface, users can effortlessly construct intricate queries, using drag-and-drop components or simple toggles to represent Boolean operators. This not only simplifies the traditionally challenging task, but also ensures users get precise, tailored results without grappling with the complexities of Boolean logic. For example, imagine a user aiming to navigate the nuances of hydrogen safety excluding storage facets in a particular regulation. Instead of manually typing out a query like “hydrogen AND safety NOT storage,” the user can visually select the terms “hydrogen” and “safety” and then deselect “storage” through an intuitive interface. This approach demystifies the process, making advanced searching accessible to all users, regardless of their familiarity with Boolean logic.

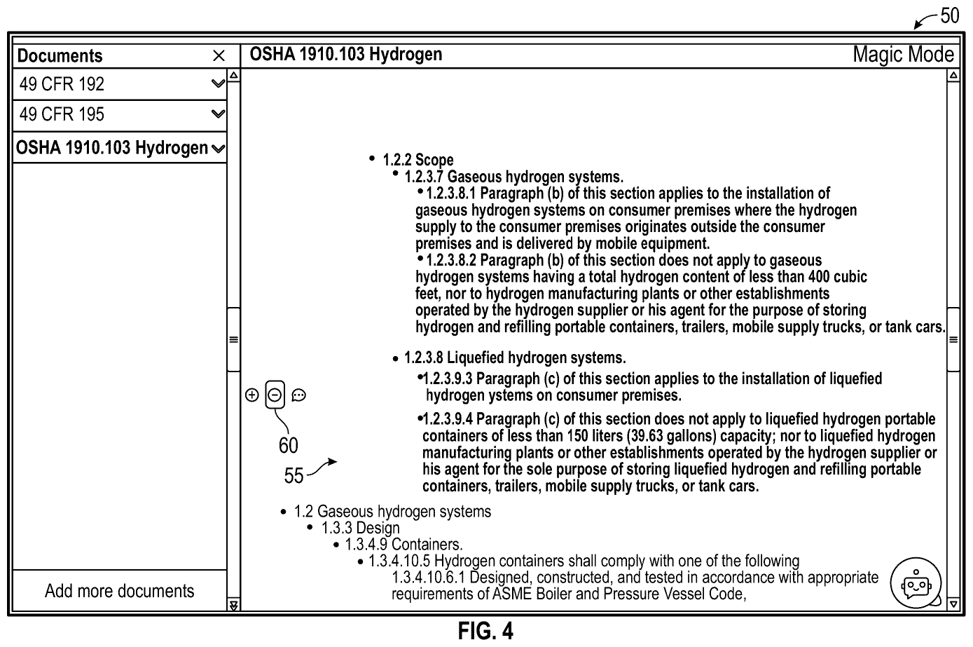

The disclosed concept also facilitates the report generation process by empowering users with enhanced control over the final content that is displayed and/or reports that are generated from the content. In particular, beyond the automated search results, users have the option to further refine what content gets displayed and/or incorporated into a report. Irrespective of the initial search outcome, users can manually exclude specific content they deem as extraneous or incorporate sections (not previously included) that they identify as pertinent. This ensures that the final report aligns seamlessly with their specific objectives and encapsulates all vital information within their report. For example, while preparing a final report using the system of the disclosed concept, a user may come across a section that, upon reflection, the user believes is not essential for the report (e.g., a report being provided to a client). The user may exercise the manual exclusion tool/feature to remove it. Later, recognizing another section that was initially omitted but holds value, the user may use the manual inclusion tool/feature to ensure its presence in the final report, thus guaranteeing the report's comprehensiveness and relevance. An exemplary implementation of this aspect is shown in the example screenshot 50 of FIG. 4 (based on the exemplary OSHA regulation), wherein a user can choose to omit from a report certain relevant content 55 by way of an exclude button 60 (an include button can similarly be used to add content as described).

In a further aspect, the disclosed concept integrates an advanced AI chatbot to help users better navigate requirements. A number of particular non-limiting AI chatbot implementations are discussed in detail elsewhere herein in connection with particular exemplary embodiments. The AI chatbot allows users to pose specific questions related to regulations and requirements. Leveraging the knowledge graph database architecture, the AI chatbot aspect of the disclosed concept can produce detailed, exhaustive, and highly accurate summaries. In at least one specific embodiment discussed elsewhere herein, by incorporating the object-oriented data structure with a large language model (LLM), the summaries provide fewer errors and a reduced risk of hallucinations often associated with large language models.

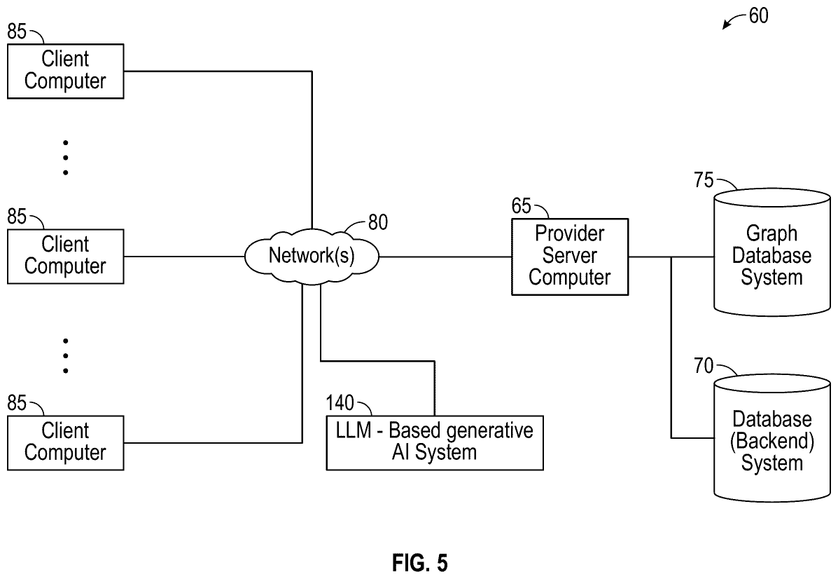

FIG. 5 is a block diagram of a system 60 for simplifying and streamlining the access to and use of regulations, standards, and requirements according to a non-limiting exemplary embodiment of the disclosed concept. As seen in FIG. 5, system 60 includes a provider server computer 65 that is provided at a provider location that is remote from the users of system 60. Provider server computer 65 includes one or more controllers that are structured and configured to implement the disclosed concept as described herein by way of a number of computer executable routines. Provider server computer 65 is coupled to a backend database system 70 and a graph database system 75. In the non-limiting exemplary embodiment, backend database system 70 is a conventional database system. Also in the non-limiting exemplary embodiment, graph database system 75 is a Neo4j graph database system developed by Neo4j, Inc., although it will be appreciated that other graph database systems may also be used in connection with the disclosed concept. Backend database system 70 is structured and configured to store a plurality of regulatory, standards, and/or requirements documents (in, for example and without limitation, Microsoft® Word format, pdf format or html format, an example of which is document 5 shown in FIG. 1) which are accessible and useable by system 60 to simplify access to an use of those documents according to the disclosed concept as described herein.

Provider server computer 65 is also coupled to a number of networks 80, including the Internet and/or one or more wired and/or wireless networks in the exemplary embodiment. System 60 also includes a plurality of client computers 85, such as PCs, tablet computers, or smartphones. Each client computer 85 is associated with a user of system 60 and is able to access provider server computer 65 by way of network(s) 80 for purposes of accessing and using one or more of the documents stored in backend database 70 according to the disclosed concept as described herein.

System 60 further includes a large language model (LLM)-based generative artificial intelligence (AI) system 140. For example, and without limitation, LLM-based generative AI system 140 may be the Generative Pre-trained Transformer 4 (GPT-4) multimodal large language model created by OpenAI or the LLaMa 2.0 open source large language model created by OpenAI created by Meta. Provider server computer 65 is able to access LLM-based generative AI system 140 through networks(s) 80 for use in connection with certain AI chatbot functionality as described herein.

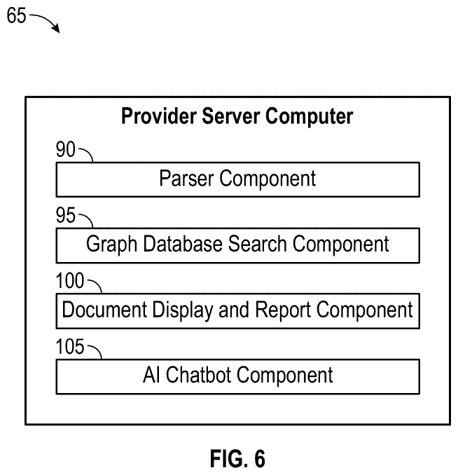

FIG. 6 is a block diagram of provider sever computer 65 according to a non-limiting exemplary embodiment. As seen in FIG. 6, provider sever computer 65 includes one or more controllers that implement a parser component 90, a graph database search component 95, a document display and report component 100, and an AI chatbot component 105.

Parser component 90 is structured and configured take each of the documents stored in backend database system 70 (i.e., the regulatory, standards, and/or requirements documents available to the user when using system 60) and convert them to a JSON format in a manner that maintains the hierarchy of each document. The JSON format of each document may be stored in backend database system 70. In addition, the JSON format/file of each document is pushed/imported to graph database system 75 by provider server computer 65. In graph database system 75, the content of each JSON format/file is converted to and represented by a KG structure/model, as shown in exemplary form in FIG. 1. The KG structure/model for each JSON format/file, and thus each document that is available to a user of system 60, includes data elements in the form of (1) nodes, (2) edges connecting nodes, and (3) attributes of each of the nodes and the associated edge(s) that define the relationship between nodes and edges.

Once a document from backend database system 70 is pushed to graph database system 75 in a file that represents the KG structure/model, provider server computer 65 is able to, at the request of a user using a client computer 85, interface with the document to enable searching (i.e., refining and omitting as described in connection with FIG. 1) within the document and the display of certain information (in the hierarchy of the original documents) on the client computer 85. These functions are provided by graph database search component 95 and document display and report component 100. In the exemplary embodiment, graph database search component 95 is a graph exploration application/tool, such as Neo4j Bloom this is configured to interact with Neo4j graph database systems.

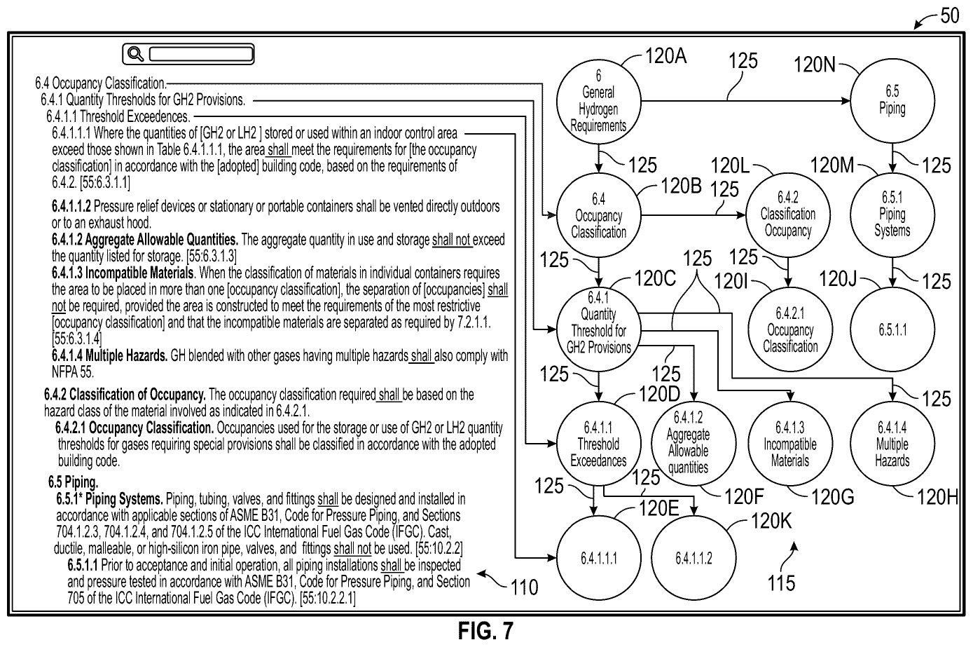

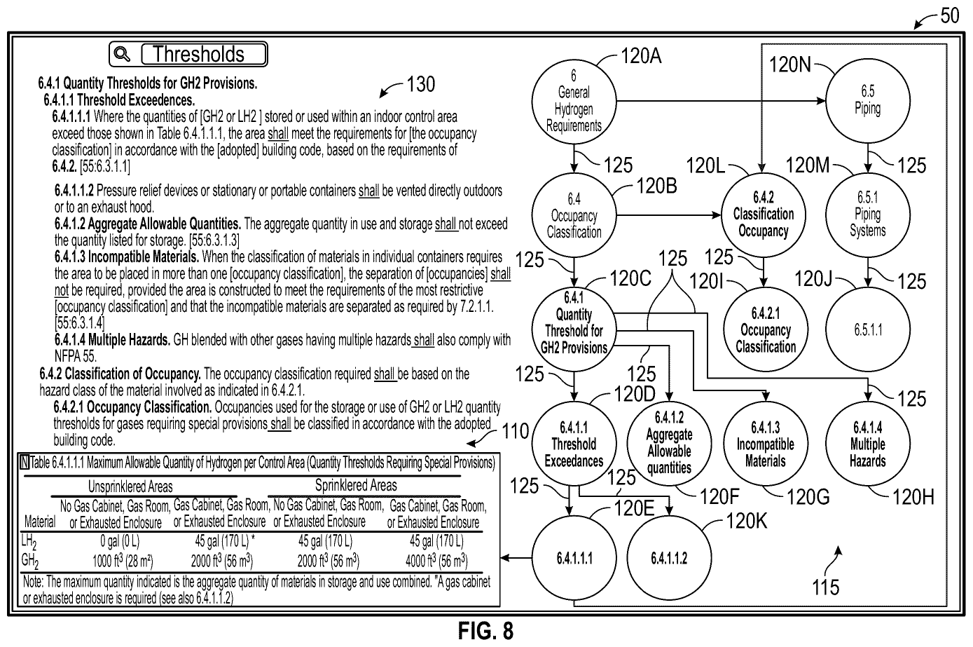

In one aspect, which was also discussed elsewhere herein, provider server computer system 65 is configured to enable a user, by way of a client computer 85, to provide search term(s) for use in connection with a selected document from backend database system 70. In response, according to an aspect of the disclosed concept, provider computer system 65, through graph database search component 95 and document display and report component 100, will enable the searching for and display of particular “first tier” and “second tier” information relevant to the search terms received from client computer system 85. More specifically, the first tier information includes all nodes that have the search term(s) in them. The second tier information includes (i) all nodes that are children of first tier nodes (children shall mean nodes that are directly or indirectly connected to the node at a lower level of the node in the KG), and (ii) all content, internal or external, that any of the first or second tier nodes refer (and may include nodes or other information such as referenced data). This aspect of the disclosed concept is illustrated schematically in FIGS. 7 and 8.

Referring to FIG. 7, it shows original content 110 from the selected document available in system 60, and KG 115 that represents that content in graph database system 75. KG 115 includes nodes 120A-120N and edges 125 as shown. FIG. 8 illustrates the state where a search term(s) (“Thresholds” in this example) has been entered and the first and second tier information has been identified. As seen in FIG. 8, nodes 120C, 120D and 120I are the first tier nodes since they contain the search term(s), nodes 120E, 120F, 120G, 120H and 120K are second tier children nodes, and node 120L and Table 6.4.1.1.1 are a second tier nodes and information, respectively, as a result of internal-internal references. Based on this, content 110 shown in FIG. 8 only shows the first and second tier information 130 in bold, while the omitted information 135 is subtly faded. The content 110 shown in FIG. 8 may then be displayed to a user on the associated client computer 85 by document display and report component 100.

In another particular non-limiting exemplary embodiment, document display and report component 100 is configured to generate data for displaying the content from stored documents as described herein on client computer 85 such that the content will be displayed in an infinite scroll configuration. In other words, the entirety of the content can be viewed by the user simply by scrolling upward and downward on the user's screen. This eliminates the need to click through multiples pages of information.

AI chatbot component 105 is provided as part of system 60 to implement and enable natural language AI chatbot functionality for system 60. The natural language AI chatbot functionality allows for human-like conversations using natural language processing techniques. AI chatbot component 105 thus helps users of system 60 to better navigate the documents stored in backend database 70. Specifically, AI chatbot component 105 enables users to pose specific questions related to such documents, and to receive accurate summaries in response.

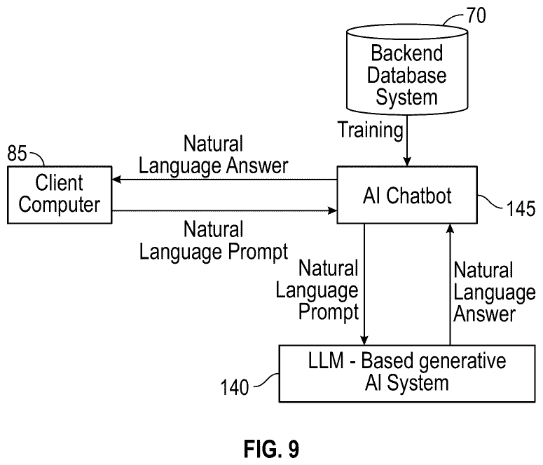

In one embodiment, illustrated schematically in FIG. 9, AI chatbot component 105 implements a natural language AI chatbot 145 that is based on LLM-based generative AI system 140 and that is accessible by users of client computers 85. AI chatbot 145 in this embodiment is trained to the text content of each document stored in backend database 70 (for example using the stored Microsoft® Word file, pdf file or html file for each document). That text will thus be part of the knowledge base of AI chatbot 145 that it uses to generate natural language answers to prompts. As will be appreciated, since this training is only text-based, it will not include useable information about the hierarchy of each document. In operation, a user will enter a natural language prompt (e.g., a question) into the AI chatbot 145 using client computer 85. AI chatbot 145 passes that prompt to LLM-based generative AI system 140. LLM-based generative AI system 140 will generate a natural language answer based on the prompt, as it has been trained to do by the third party developer thereof based on a very large volume of publicly available documents and/or licensed non-public data. That natural language answer is returned to AI chatbot 145, which provides the answer to client computer 85 for viewing by the user. In one alternative implementation of AI chatbot 145, it is configured to use as the knowledge base for its answers only the text content of each document stored in backend database 70. This will help to eliminate “hallucinations” in the answers returned by AI chatbot 145. However, since AI chatbot is still based on LLM-based generative AI system 140, “hallucinations” will, to some degree, likely still be present.

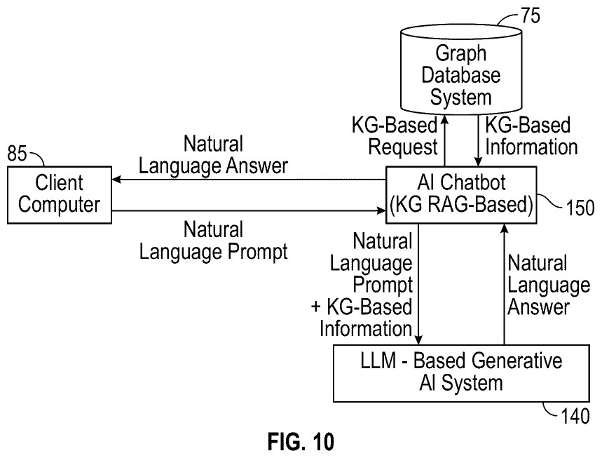

An alternative chatbot embodiment is based on retrieval augmented generation (RAG). In this embodiment, illustrated schematically in FIG. 10, AI chatbot component 105 implements an AI chatbot 150 that includes as part of its functionality a knowledge graph RAG query engine for a knowledge graph-enabled RAG approach to retrieving information from knowledge graphs. AI chatbot 150 is accessible by users of client computers 85. AI chatbot 150 is not trained to the text content of each document stored in backend database 70. Rather, in operation, a user will enter a natural language prompt (e.g., a question) into the AI chatbot 150 using client computer 85. AI chatbot 150, and specifically the KG RAG query engine thereof, generates a KG-based request based on the received prompt and uses that KG-based request to query graph database system 75. In response, graph database system 75 returns KG-based information that is responsive to the query. AI chatbot 150 passes the original prompt and the KG-based information to LLM-based generative AI system 140. LLM-based generative AI system 140 will generate a natural language answer based on the original prompt and the KG-based information. That natural language answer is returned to AI chatbot 150, which provides the answer to client computer 85 for viewing by the user. It is believed that this embodiment will more significantly reduce the likelihood of “hallucinations” in the answers returned by AI chatbot 150.

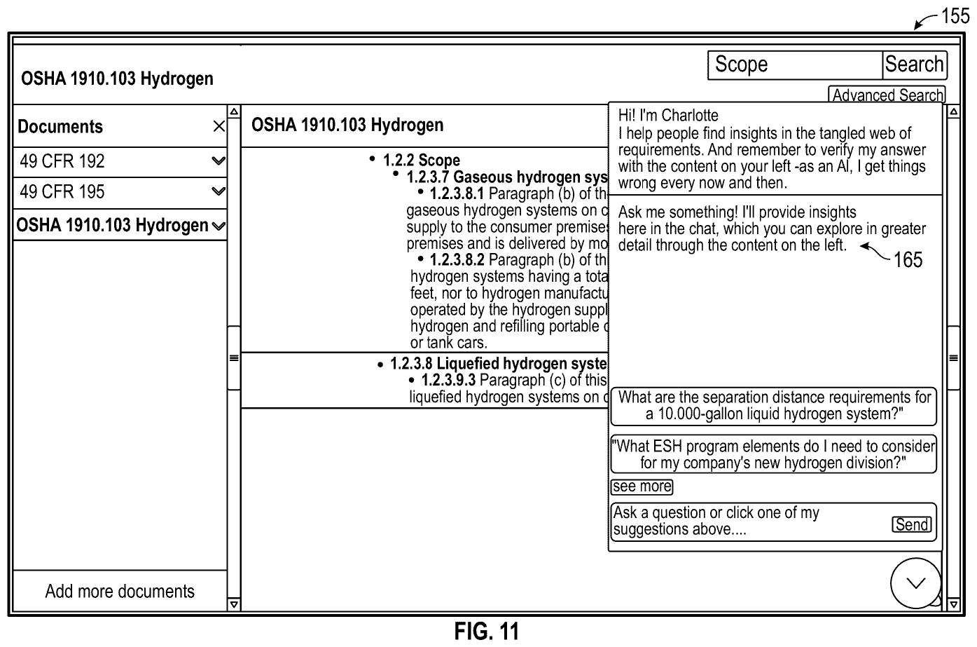

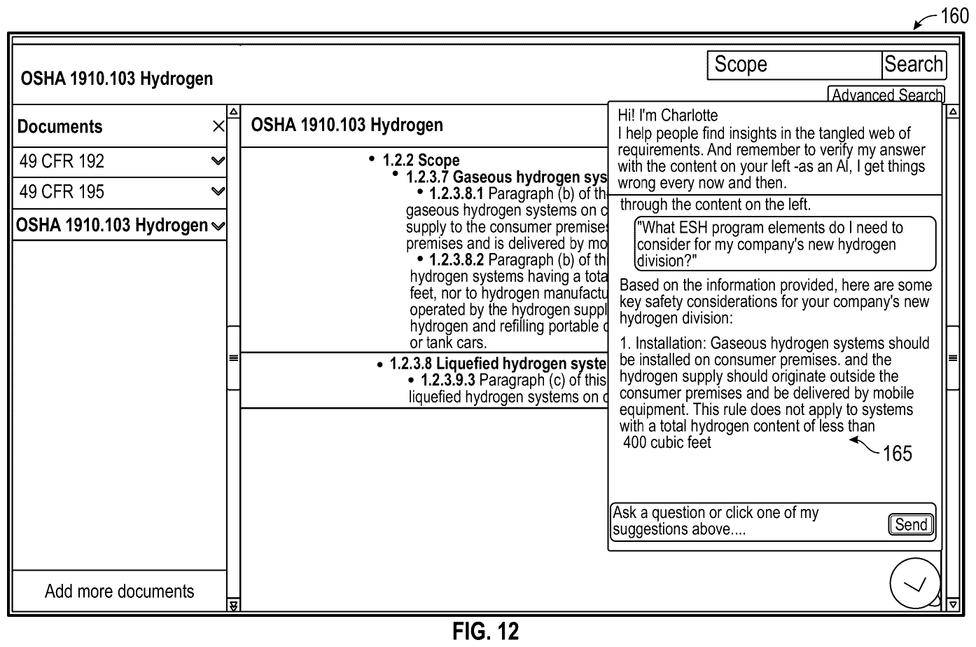

FIGS. 11 and 12 show exemplary screenshots 155 and 160 illustrating operation of either AI chatbot 145 or AI chatbot 150 from the user's perspective as displayed on a client computer 85. As shown, an AI chatbot pop-up 165 is provided for receiving user prompts and providing chatbot responses.

According to a further aspect of the disclosed concept, After selecting the documents to be included within backend database system 70 to be used by system 60 as described herein, the user is able to input a detailed description of their scope of work that they intend to use the tool (i.e., system 60) for (e.g., describing the design basis for their project, chemicals used, physical states, location, materials used, process parameters, etc.). System 60 in this aspect tool would use AI semantic analysis and the pre-defined knowledge graph semantic ontology to pre-construct an advanced Boolean search for the user, so that irrelevant content is eliminated automatically once they begin their code review. From a high level, it would operate by passing the Scope of Work across an LLM API (e.g., OpenAI), with a prompt such as “Review the content below and provide terms for an automated Boolean search, including conditions for the operations. Include both explicitly referenced terms, but also semantic terms that may also be relevant (e.g., a mention of hydrogen gas will also search for flammable gas and pressurized gas).” Once system 60 has the terms and conditions generated from the LLM, it can pass them along to a Boolean search engine to pre-structure the operator to best assist the users with pre-refining their results.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A system for facilitating compliance by a user with regulations, standards and/or requirements using a client computer, the system comprising:
a provider computing system located remotely from the client computer;
a backend database system coupled to the provider computing system, the backend database system storing a plurality of regulatory, standards and/or requirements documents, wherein each of the regulatory, standards and/or requirements documents is stored in a text-based format and is organized according to a respective predetermined hierarchy; and
a graph database system coupled to the computing device;
wherein the provider computing system is structured and configured to:
implement a parser component, the parser component being configured to convert each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document;
for each of the regulatory, standards and/or requirements documents in the JSON format, push the regulatory, standards and/or requirements document in the JSON format to the graph database system wherein the regulatory, standards and/or requirements document in the JSON format is represented by a knowledge graph (KG) structure;
for a particular one of the regulatory, standards and/or requirements documents stored in the backend database system, receive a number of search terms from the client computer;
identify a number of nodes in the KG structure corresponding to the particular one of the regulatory, standards and/or requirements documents based on the number of search terms; and
cause the client computer to display a number of portions of the particular one of the regulatory, standards and/or requirements documents based on the identified nodes in a manner that preserves the hierarchy of the particular one of the regulatory, standards and/or requirements documents.

2. The system according to claim 1, wherein the provider computing system is structured and configured to cause the client computer to, at least temporarily, display only the number of portions of the particular one of the regulatory, standards and/or requirements documents based on the identified nodes.

3. The system according to claim 2, wherein the provider computing system is structured and configured to, responsive to input from the client computer, to cause certain other portions of the of the particular one of the regulatory, standards and/or requirements documents to be displayed in the manner that the hierarchy of the particular one of the regulatory, standards and/or requirements documents along with the number of portions of the particular one of the regulatory, standards and/or requirements documents based on the identified nodes.

4. The system according to claim 1, wherein the provider computing system is structured and configured to cause the client computer to display the number of portions of the particular one of the regulatory, standards and/or requirements documents based on the identified nodes in a first format and certain other portions of the particular one of the regulatory, standards and/or requirements documents in the manner that the hierarchy of the particular one of the regulatory, standards and/or requirements documents in a second format different that the first format.

5. The system according to claim 4, wherein the second format is a faded format as compared to the first format.

6. The system according to claim 1, wherein the identified number of nodes includes all nodes in the KG structure that contain the one or more search terms, all children nodes of the nodes in the KG structure that contain the one or more search terms, and all nodes in the KG structure that are referenced by the nodes in the KG structure that contain the one or more search terms and/or the children nodes.

7. The system according to claim 6, wherein the provider computing system is structured and configured to cause the client computer to display certain additional information that is referenced by the identified number of nodes.

8. The system according to claim 1, wherein the provider computing system is structured and configured to implement an artificial intelligence (AI) chatbot component, the AI chatbot component enabling an AI chatbot that is configured to (i) allow the client computer to receive a prompt relating to the particular one of the regulatory, standards and/or requirements documents and provide the prompt to the AI chatbot, and (ii) provide an answer to the prompt.

9. The system according to claim 8, wherein the AI chatbot is a natural language AI chatbot that is based on an LLM-based generative AI system, wherein the AI chatbot is trained on text content of each of the regulatory, standards and/or requirements documents stored in the backend database system.

10. The system according to claim 9, wherein the AI chatbot is configured to use as its knowledge base for its answers only the text content of each of the regulatory, standards and/or requirements documents stored in the backend database system.

11. The system according to claim 8, wherein the AI chatbot includes a knowledge graph RAG query engine.

12. The system according to claim 11, wherein the AI chatbot is configured to (i) generate a KG-based request based on the prompt, (ii) use the KG-based request to query the graph database system and in response receive KG-based information from the graph database system that is responsive to the query, (iii) pass the prompt and the KG-based information to an LLM-based generative AI system, (iv) receive a natural language answer from the LLM-based generative AI system based on the prompt and the KG-based information, and (v) provide the natural language answer to the client computer.

13. A method for facilitating compliance by a user with regulations, standards and/or requirements, comprising:
storing in a backend database system a plurality of regulatory, standards and/or requirements documents, wherein each of the regulatory, standards and/or requirements documents is stored in a text-based format and is organized according to a respective predetermined hierarchy;
converting each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document;
for each of the regulatory, standards and/or requirements documents in the JSON format, pushing the regulatory, standards and/or requirements document in the JSON format to a graph database system wherein the regulatory, standards and/or requirements document in the JSON format is represented by a knowledge graph (KG) structure;
for a particular one of the regulatory, standards and/or requirements documents stored in the backend database system, receiving a number of search terms from the user;
identifying a number of nodes in the KG structure corresponding to the particular one of the regulatory, standards and/or requirements documents based on the number of search terms; and
causing a number of portions of the particular one of the regulatory, standards and/or requirements documents based on the identified nodes to be displayed to the user in a manner that preserves the hierarchy of the particular one of the regulatory, standards and/or requirements documents.

14. The method according to claim 13, wherein the causing step includes, at least temporarily, displaying only the number of portions of the particular one of the regulatory, standards and/or requirements documents based on the identified nodes.

15. The method according to claim 14, wherein, responsive to input from the user, cause certain other portions of the of the particular one of the regulatory, standards and/or requirements documents to be displayed to the user in the manner that the hierarchy of the particular one of the regulatory, standards and/or requirements documents along with the number of portions of the particular one of the regulatory, standards and/or requirements documents based on the identified nodes.

16. The method according to claim 13, wherein the causing step includes cause the number of portions of the particular one of the regulatory, standards and/or requirements documents based on the identified nodes to be displayed in a first format and certain other portions of the particular one of the regulatory, standards and/or requirements documents in the manner that the hierarchy of the particular one of the regulatory, standards and/or requirements documents to be displayed in a second format different that the first format.

17. The method according to claim 16, wherein the second format is a faded format as compared to the first format.

18. The method according to claim 13, wherein the identified number of nodes includes all nodes in the KG structure that contain the one or more search terms, all children nodes of the nodes in the KG structure that contain the one or more search terms, and all nodes in the KG structure that are referenced by the nodes in the KG structure that contain the one or more search terms and/or the children nodes.

19. The method according to claim 18, wherein the causing step includes causing certain additional information that is referenced by the identified number of nodes to be displayed to the user.

20. The method according to claim 13, providing an AI chatbot that is configured to (i) allow the user to provide a prompt relating to the particular one of the regulatory, standards and/or requirements documents to the AI chatbot, and (ii) provide an answer to the prompt.

21. The method according to claim 20, wherein the AI chatbot is a natural language AI chatbot that is based on an LLM-based generative AI system, wherein the AI chatbot is trained on text content of each of the regulatory, standards and/or requirements documents stored in the backend database system.

22. The method according to claim 21, wherein the AI chatbot is configured to use as its knowledge base for its answers only the text content of each of the regulatory, standards and/or requirements documents stored in the backend database system.

23. The method according to claim 20, wherein the AI chatbot includes a knowledge graph RAG query engine.

24. The method according to claim 23, wherein the AI chatbot is configured to (i) generate a KG-based request based on the prompt, (ii) use the KG-based request to query the graph database system and in response receive KG-based information from the graph database system that is responsive to the query, (iii) pass the prompt and the KG-based information to an LLM-based generative AI system, (iv) receive a natural language answer from the LLM-based generative AI system based on the prompt and the KG-based information, and (v) provide the natural language answer to the user.

25. A system for facilitating compliance by a user with regulations, standards and/or requirements using a client computer, the system comprising:
a provider computing system located remotely from the client computer;
a backend database system coupled to the provider computing system, the backend database system storing a plurality of regulatory, standards and/or requirements documents, wherein each of the regulatory, standards and/or requirements documents is stored in a text-based format and is organized according to a respective predetermined hierarchy; and
a graph database system coupled to the computing device;
wherein the provider computing system is structured and configured to:
implement a parser component, the parser component being configured to convert each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document;
for each of the regulatory, standards and/or requirements documents in the JSON format, push the regulatory, standards and/or requirements document in the JSON format to the graph database system wherein the regulatory, standards and/or requirements document in the JSON format is represented by a knowledge graph (KG) structure;
implement an artificial intelligence (AI) chatbot component, the AI chatbot component enabling an AI chatbot that is configured to (i) allow the client computer to receive a prompt relating to a particular one of the regulatory, standards and/or requirements documents and provide the prompt to the AI chatbot, and (ii) provide an answer to the prompt.

26. The system according to claim 25, wherein the AI chatbot is a natural language AI chatbot that is based on an LLM-based generative AI system, wherein the AI chatbot is trained on text content of each of the regulatory, standards and/or requirements documents stored in the backend database system.

27. The system according to claim 26, wherein the AI chatbot is configured to use as its knowledge base for its answers only the text content of each of the regulatory, standards and/or requirements documents stored in the backend database system.

28. The system according to claim 26, wherein the AI chatbot includes a knowledge graph RAG query engine.

29. The system according to claim 28, wherein the AI chatbot is configured to (i) generate a KG-based request based on the prompt, (ii) use the KG-based request to query the graph database system and in response receive KG-based information from the graph database system that is responsive to the query, (iii) pass the prompt and the KG-based information to an LLM-based generative AI system, (iv) receive a natural language answer from the LLM-based generative AI system based on the prompt and the KG-based information, and (v) provide the natural language answer to the client computer.

30. A method for facilitating compliance by a user with regulations, standards and/or requirements, comprising:
storing in a backend database system a plurality of regulatory, standards and/or requirements documents, wherein each of the regulatory, standards and/or requirements documents is stored in a text-based format and is organized according to a respective predetermined hierarchy;
converting each of the regulatory, standards and/or requirements documents into a JavaScript Object Notation (JSON) format, wherein each of the regulatory, standards and/or requirements documents in the JSON format maintains the predetermined hierarchy of the regulatory, standards and/or requirements document;
for each of the regulatory, standards and/or requirements documents in the JSON format, pushing the regulatory, standards and/or requirements document in the JSON format to a graph database system wherein the regulatory, standards and/or requirements document in the JSON format is represented by a knowledge graph (KG) structure; and
providing an AI chatbot that is configured to (i) allow the user to provide a prompt relating to a particular one of the regulatory, standards and/or requirements documents to the AI chatbot, and (ii) provide an answer to the prompt.

31. The method according to claim 30, wherein the AI chatbot is a natural language AI chatbot that is based on an LLM-based generative AI system, wherein the AI chatbot is trained on text content of each of the regulatory, standards and/or requirements documents stored in the backend database system.

32. The method according to claim 31, wherein the AI chatbot is configured to use as its knowledge base for its answers only the text content of each of the regulatory, standards and/or requirements documents stored in the backend database system.

33. The method according to claim 30, wherein the AI chatbot includes a knowledge graph RAG query engine.

34. The method according to claim 33, wherein the AI chatbot is configured to (i) generate a KG-based request based on the prompt, (ii) use the KG-based request to query the graph database system and in response receive KG-based information from the graph database system that is responsive to the query, (iii) pass the prompt and the KG-based information to an LLM-based generative AI system, (iv) receive a natural language answer from the LLM-based generative AI system based on the prompt and the KG-based information, and (v) provide the natural language answer to the user.
